(19) United States
(12) Patent Application Publication
(10) Pub. No.: US 2021/0058154 A1
(43) Pub. Date: Feb. 25, 2021

(54) METHOD FOR MONITORING AN OPTICAL COMMUNICATIONS SYSTEM

(71) Applicant: POLITECNICO DI MILANO, Milano (IT)

(72) Inventors: Francesco MUSUMECI, Milano (IT); Massimo TORNATORE, Milano (IT); Achille PATTAVINA, Milano (IT); Shahin SHAHKARAMI, Milano (IT)

(73) Assignee: PoliteCnico dI Milano, Milano (IT)

(21) Appl. No.: 16/978,477

(22) PCT Filed: Mar. 8, 2019
(86) PCT No.: PCT/EP2019/055874

§ 371 Date: Sep. 4, 2020

(30) Foreign Application Priority Data
Mar. 8, 2018 (IT) 102018000003363

(51) Int. Cl. H04B 10/079; G06N 3/08

(52) U.S. Cl. CPC H04B 10/0793; G06N 20/10; G06N 3/08; H04B 10/07953

(57) ABSTRACT

It is described a method for monitoring an optical communications system comprising at least one optical channel connecting a transmitter and a receiver. The method comprises: measuring, at the receiver, a transmission parameter of the optical channel for a pre-defined measuring time interval; on the basis of the measurements of the transmission parameter in the time interval, checking the presence of at least one anomaly in the measurements, the at least one anomaly being indicative of a subsequent failure of the system; and in the presence of the at least one anomaly, applying an identification algorithm to the measurements, the algorithm comprising a classifier, wherein the classifier is configured to, on the basis of the measurements, identify a cause of the failure, the classifier being based on a machine learning technique.

### TECHNICAL FIELD

The present invention relates to the field of optical communication systems. In particular, the present invention relates to the field of methods for monitoring an optical communications system.

### BACKGROUND ART

As known, in an optical communications system, different types of failures may occur which can degrade the quality of the signal at the receiver.

The different types of failures can be classified into two categories: the so-called “hard-failures” occur in a completely unexpected and unpredictable way and are caused by sudden events, such as interruptions of the fiber optic cables, while the so-called “soft-failures” correspond to a gradual worsening of the signal quality and may be caused by, for example, a misalignment of cascaded filters along the optical link, or by a malfunction of one or more optical amplifiers. The worsening of the signal quality associated with a soft-failure may occur gradually over a relatively long time scale (hours or days). In particular, soft-failures can induce anomalies in the BER values at the receiver and eventually lead to packet loss or interruption of the offered service.

Since, as anticipated, soft-failures may occur on a relatively long time scale, they prove to be potentially predictable. Therefore, in principle, a soft-failure can be anticipated by adopting a preventive measure such as for instance a reconfiguration of the network devices of the “make-before-break” type.

Current optical communications networks use transmission and reception devices based on coherent technology. These devices allow monitoring the quality of the received signal by collecting data such as, for example, the optical signal-to-noise ratio (OSNR), the Q factor (Q-factor) and the BER measured before applying the decoding mechanism according to the Forward Error Correction (FEC) technique, which is typically implemented at the receiver. The BER measured before FEC decoding is also referred to as “pre-FEC BER”. Herein below, unless otherwise specified, the term “BER” will indicate the pre-FEC BER.

Methods and systems for detecting failures in an optical communications network are known.

EP 2 533 549 A1 discloses a fault detection method comprising the steps of collecting operational parameters of the optical network, collecting information about the structure of the optical network, providing diagnosis outputs by a diagnosis engine analyzing the structure information and the operational parameters, and deriving optical network faults from the diagnosis outputs. The operational parameters are related to equipment (type), Quality-of-Service (BER) and/or architecture (ID) of the optical network. The optical network faults derived from the diagnosis outputs may concern equipment issues, interoperability problems and/or physical defects. The diagnosis engine generates the diagnosis outputs by using decision trees, Bayesian network techniques and/or multivariate classification techniques.

U.S. Pat. No. 6,965,736 B1 discloses a method for monitoring the transmission quality of an optical transmission system, such as, for example, an optical wavelength division-multiplex network. An amplitude histogram of an optical signal (transmission signal) transmitted over the transmission system may be plotted and classified, with the assistance of a neural network, according to bit error rates and/or causes of faults.

### SUMMARY OF THE INVENTION

The inventors have noticed that the method described in EP 2 533 549 A1 finds application in a Passive Optical Network (PON) comprising one or more centralized Optical Line Terminations (OLT), each one connected to one or more groups of Optical Network Terminals (ONT) at the users of the network. The connection of the devices is realized through a passive optical network. The diagnostic method described in EP 2 533 549 A1 allows identifying a type of faulty devices (which can be the boards at the OLTs or the ONTs), or single faulty devices, or, also, a problem of interoperability between a certain ONT type and a certain board type, or a physical defect of the ONTs of a certain group, together with the location of the defect. Thus, the inventors have noticed that the described method provides for collecting, at the input of the diagnostic engine, information on the network structure and on the type of devices present therein, which makes the method applicable only to a specific optical network type or, in any case, to an optical network whose structure and composition is well known. Moreover, the described method does not allow to identify the cause of the failure present in the optical network: at most, it provides indications on the presumed presence of a failure at a device or at network devices of a certain type, however without providing an indication of why the failure is occurring.

As for the method described in U.S. Pat. No. 6,965,736 B1, the inventors have noticed that it uses amplitude information of the received optical signal to estimate the BER values. The method can also provide a classification on whether these values are produced by the presence of noise, cross-talk or signal distortion. However, the described method does not provide an indication about the cause of the presence of noise, cross-talk or distortions.

Finally, the inventors have noticed that both methods described above allow at most to detect a failure (without identifying the cause thereof) at a time subsequent to the occurrence of the failure itself, and that therefore none of the known methods described above allow to predict in advance the occurrence of a soft-failure in the optical communications network.

Therefore, it is an object of the present invention to provide a method for monitoring any optical communications system (i.e., not necessarily a priori known in its structure and composition) allowing to detect a soft-failure in the system and to identify the cause thereof, also allowing to provide such detection and identification in advance of the actual occurrence of the soft-failure.

According to a first aspect, the present invention provides a method for monitoring an optical communications system comprising at least one optical channel connecting a transmitter and a receiver, the method comprising:
a) measuring, at the receiver, a transmission parameter of the optical channel for a pre-defined measuring time interval;
b) on the basis of the measurements of the transmission parameter in the time interval, checking the presence of at least one anomaly in the measurements, the at least one anomaly being indicative of a subsequent failure of the system; and
c) in the presence of the at least one anomaly, applying an identification algorithm to the measurements, the algorithm comprising a classifier, wherein the classifier is configured to, on the basis of the measurements, identify a cause of the failure, the classifier being based on a machine learning technique.

Preferably, step a) of the method comprises:
a1) sampling the values of the transmission parameter in the interval with a pre-defined period and collecting the samples in a measurement window of the transmission parameter having a pre-defined duration; and
a2) determining, starting from the samples, one or more input data for the classifier,
   wherein the input data comprises one or more statistical values related to the samples of the transmission parameter in the measurement window.

Preferably, the statistical values comprise one or more of the following: a mean value, a maximum value, a minimum value, a standard deviation, a mean square value, a peak-to-peak value, one or more spectrum components of the samples.

Preferably, the method comprises collecting the samples of the transmission parameter in at least two consecutive measurement windows, wherein the at least two measurement windows are disjoint or at least partially overlapped, checking the presence of an anomaly in each measurement window of the at least two measurement windows and, in the presence of an anomaly in each measurement window, applying the identification algorithm.

Preferably, the transmission parameter is the pre-FEC BER associated with said optical channel.

Preferably, the machine learning technique comprises an artificial neural network.

According to embodiments of the present invention, step b) comprises applying a detection algorithm to the measurements, the detection algorithm comprising a further classifier based on a further machine learning technique.

Preferably, the further machine learning technique comprises one of the following: binary support vector machine (SVM), random forest, multiclass SVM, artificial neural network.

Preferably, the method further comprises an initial configuration step, and the initial configuration step comprises applying an automatic learning algorithm to train the classifier based on a set of measurements of the transmission parameter, the set of measurements being indicative of at least two possible causes of the failure.

According to a second aspect, the present invention provides a monitoring unit for an optical communications system, the system comprising at least one optical channel connecting a transmitter and a receiver, said unit comprising:
a data acquisition module configured to collect from the receiver measurements of a transmission parameter of the optical channel for a pre-defined measuring time interval;
a detection module configured to, on the basis of the measurements of the transmission parameter in the time interval, check the presence of at least one anomaly in the measurements, the at least one anomaly being indicative of a subsequent failure of the system; and
an identification module configured to, in the presence of the at least one anomaly, apply an identification algorithm to the measurements, the algorithm comprising a classifier, wherein the classifier is configured to, on the basis of the measurements, identify a cause of the failure, the classifier being based on a machine learning technique.

### BRIEF DESCRIPTION OF THE DRAWINGS

The present invention will become clearer from the following detailed description, given by way of non-limiting example, to be read with reference to the included figures wherein:

FIG. 1 is an exemplary scheme of a optical communications system;

FIGS. 2a and 2b show, respectively, BER measurement data in the absence of and in the presence of a soft-failure;

FIG. 3 is a flowchart representing the steps of the method according to the present invention;

FIG. 4 is a flowchart representing the initial configuration steps for the implementation of the method according to the present invention;

FIG. 5 schematically represents an exemplary optical communications system used to test the method according to the present invention; and

FIGS. 6a, 6b and 7 are graphs illustrating the results of tests performed on the optical communications system of FIG. 5.

### DETAILED DESCRIPTION OF PREFERRED EMBODIMENTS OF THE INVENTION

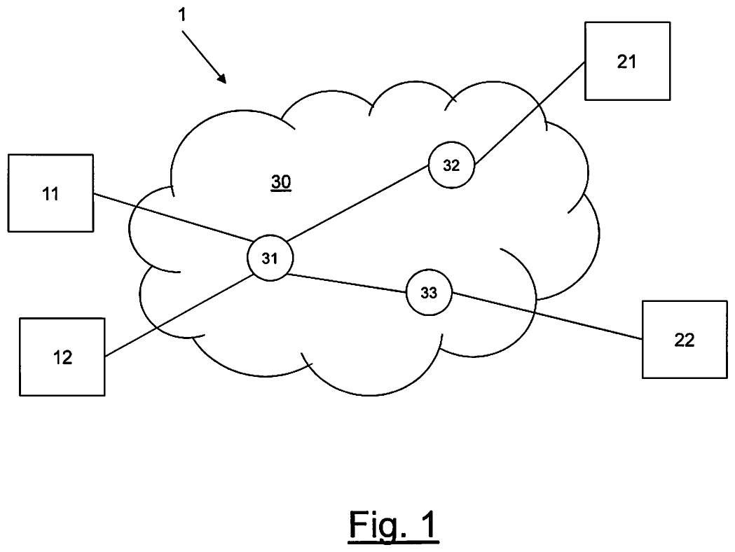

FIG. 1 schematically shows an exemplary optical communications system, indicated with the reference number 1. The optical system 1, for example, may be a WDM optical system. The optical communications system 1 comprises a first source node comprising a first transmitter 11 and a second source node comprising a second transmitter 12 respectively connected to a first destination node comprising a first receiver 21 and a second destination node comprising a second receiver 22. The connection between source nodes and destination nodes is made through an optical communications network 30 comprising one ore more intermediate nodes connected by means of optical fiber. For example, the optical communications network 30 of FIG. 1 comprises three intermediate nodes 31, 32, 33. Each intermediate node may for example comprise a switch and/or an optical amplifier and/or one or more filters.

The optical communications network 30 preferably provides the users of the system 1 with a number of optical channels (or lightpaths) that can be established between the source nodes and the destination nodes, each one comprising one or more intermediate nodes 31, 32, 33 of the optical communications network 30 and the optical fiber portions between the considered intermediate nodes. Generally, known WDM systems can comprise optical fiber portions of length equal to about 80 km spaced by the presence of so-called “in-line” amplifiers. Fiber optic portions may also comprise other types of devices, such as, for instance, Variable Optical Attenuators (VOA), which are typically used to equalize the signal strength at various wavelengths, and compensation apparatuses, for example for the compensation of the chromatic dispersion or of the polarization mode dispersion.

Preferably, the first receiver 21 and the second receiver 22 comprise a coherent optical receiver. The coherent optical receiver structure is known to the expert in the art and will not be further described in the following.

According to embodiments of the present invention, the method for monitoring an optical communications system comprises measuring the values of at least one transmission parameter related to an optical channel at the receiver of a node of the considered optical communications system, storing and processing such values and finally analyse them to detect the presence of anomalies therein and to identify the cause of a failure (in the present description this term will be used to indicate a soft-failure) of the system indicated in advance by the presence of such anomalies, i.e. the failure which is in fact the cause of these anomalies.

In particular, the method according to the present invention preferably comprises, at one or more receivers of the considered optical communications system, measuring one ore more transmission parameters associated with the optical channels arriving at the receiver itself, such as for instance the pre-FEC BER or the optical signal to noise ratio (OSNR). For this purpose, each receiver 21, 22 of the system 1 preferably comprises one or more modules for measuring the transmission parameters associated with the different optical channels. In particular, according to embodiments of the present invention, each receiver 21, 22 of the system 1 comprises a module implementing the FEC decoding and a module for measuring the BER on the input signal of the module implementing the FEC decoding, namely a module for measuring the pre-FEC BER.

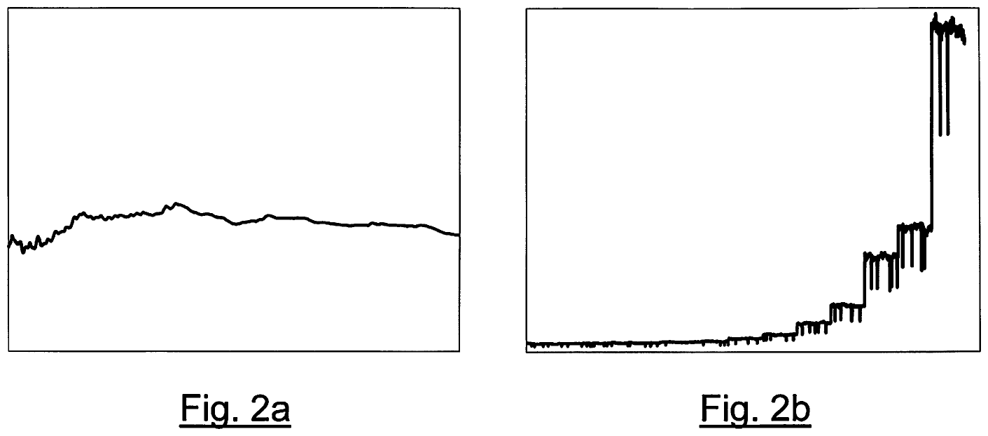

FIGS. 2a and 2b show two graphs illustrating in a schematic and exemplary way a pre-FEC BER measurement of an optical channel at a receiver of an exemplary optical communications system and not shown in the Figures. The pre-FEC BER measurement refers to a time interval of about 24 hours for the graph of FIG. 2a, and about 1 hour for the graph in FIG. 2b. In both the graphs the values of pre-FEC BER (axis of ordinates) are represented as a function of time (axis of abscissae). Therefore the two graphs do not have the same scale both on the axis of the ordinates and the axis of the abscissae, and serve only to illustrate the difference in the trend of the pre-FEC BER measurement in absence and in presence of a soft-failure. The graph of FIG. 2a shows a “normal” trend of the pre-FEC BER, i.e. a trend of the pre-FEC BER that does not correspond to any soft-failure associated with the corresponding optical channel. In this graph the pre-FEC BER has a substantially regular and “almost flat” trend in the monitored time interval. The graph of FIG. 2b shows instead a trend of the pre-FEC BER which deviates from the so-called “normal” trend due to a soft-failure and presents an anomalous trend, corresponding to an increase in the values of the pre-FEC BER first gradually and then more abruptly than the initial values.

More generally, in the following description and in the claims, the term “anomaly” associated with the time trend of the value of a transmission parameter (for example, the pre-FEC BER) of an optical channel within a certain measurement time interval will indicate a condition for which the values of the parameter in the considered interval assume a trend that deviates from that corresponding to a regular trend for that parameter (where “regular trend” indicates a trend indicative of a no failure situation), and assumes a trend indicative of the subsequent occurrence of a failure (in particular a soft-failure) in the system over the considered optical channel. Within the context of the present invention, the presence of one or more anomalies associated with a transmission parameter within one or more corresponding consecutive measurement intervals (possibly overlapped) preferably indicates the subsequent occurrence of a soft-failure on the considered optical channel. In other words, the presence of one or more anomalies anticipates the occurrence of the failure on the considered optical channel. For example, a soft-failure can correspond to a condition of misalignment of the filters of the considered optical channel, or to a condition of excessive attenuation of the optical channel, or to a laser and/or photodiode malfunctioning condition, or to a fiber optic bending, or to a combination of the aforementioned events.

According to embodiments of the present invention, each receiver of the optical communications system 1 cooperates with a monitoring unit of the system (not shown in the drawings). Preferably, this unit is a software module configured to be executed on the same device housing the receiver or on one or more external devices connected to it. For example, the monitoring unit may reside in a centralized network controller, in particular a Software Defined Networking (SDN) controller communicating with the receivers of the nodes of the optical communications system 1.

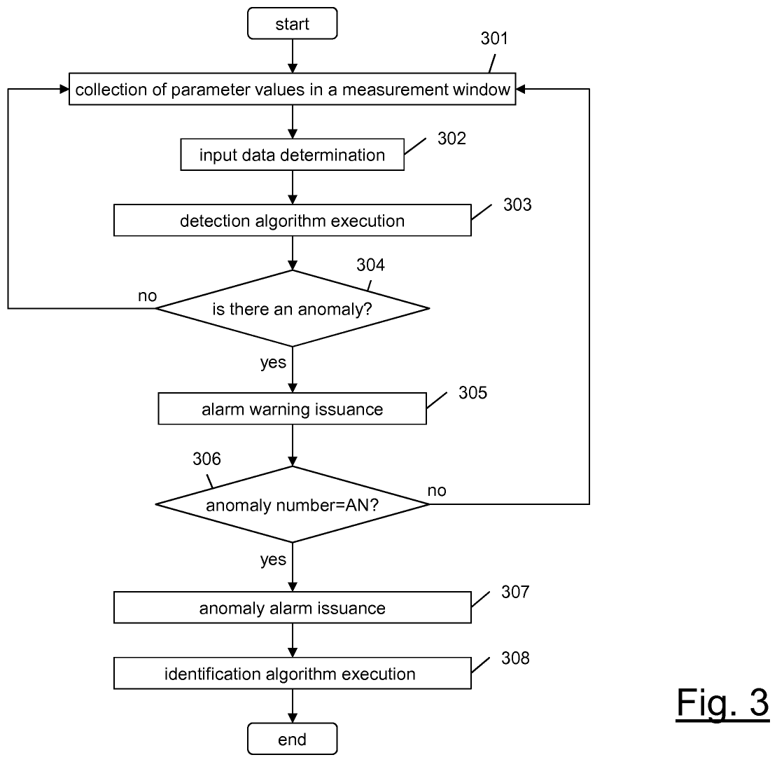

Preferably, the monitoring unit of the system comprises a data acquisition module, a detection module and an identification module. The functions of these modules will become clear from the following detailed description, which will refer to the flowchart of FIG. 3. In particular, the flowchart of FIG. 3 illustrates the operation of the method according to the present invention when applied “on field” for a soft-failure detection and identification.

In particular, the method of the present invention will be described below by referring to the measurement of a single transmission parameter of an optical channel at the considered receiver. Such transmission parameter can be, for example, the pre-FEC BER. However, this description does not constitute a limitation since the described method can use the values of different transmission parameters related to the same optical channel (for example, pre-FEC BER and OSNR) and can be applied for monitoring all optical channels that arrive at the same receiver.

According to the present invention, during its operation, the receiver 21 preferably provides a continuous measurement of the considered transmission parameter. In particular, the receiver 21 samples the value of the transmission parameter with a pre-defined sampling period which may be comprised, for example, between 3 seconds and 110 seconds.

At the beginning of the procedure, moreover, the receiver 21 preferably initializes a counter which indicates the number of anomalies found in the samples of the transmission parameter, as will be described below. For example, at the start of the procedure the counter value is set to zero.

Once the samples of the transmission parameter have been acquired for a certain measurement time interval, the receiver 21 preferably forwards them to the data acquisition module of the monitoring unit, which performs a pre-processing of such samples of the transmission parameter (for example, to reduce noise on data). This step is not shown in the diagram of FIG. 3. At step 301, the data acquisition module preferably collects the pre-processed samples of the transmission parameter value acquired by the receiver in the considered measurement interval and organizes them in a so-called “measurement window” of the parameter. For example, the measurement window may have a duration comprised between 5 and 300 minutes, for example 15 minutes.

More generally, according to the present invention, the data acquisition module preferably organizes the transmission parameter samples acquired by the receiver in a sequence of measurement windows, which can be disjoint or at least partially overlapped in time. In other words, two successive measurement windows may comprise no common samples or they may comprise one or more common samples.

At step 302, the data acquisition module preferably determines, for each measurement window of the transmission parameter, one or more input data to be sent to the detection module. To do this, the data acquisition module can also determine the spectrum of the values of the considered measurement window, by applying the known Fast Fourier Transform (FFT) algorithm. Preferably, the input data comprises one or more statistical values related to the measurements of the transmission parameter in the considered measurement window, such as for instance one or more of the following values: the mean value of the samples, the maximum value of the samples, the minimum value of the samples, the standard deviation of the samples, the mean square value of the samples, the peak-to-peak value of the samples (i.e., the difference between the minimum vale and the maximum value), one or more spectrum components.

At step 303, the input data is preferably forwarded from the acquisition module to the detection module. In particular, this module performs a detection algorithm verifying the presence of an anomaly in the measurement window. In particular, preferably, the detection module maps the input data into one of two classes, a first class corresponding to the presence of an anomaly in the considered measurement window and a second class corresponding to the absence of an anomaly in the same measurement window. As long as the detection module does not detect any anomaly, steps 301-303 are repeated for subsequent measurement windows of the samples collected at the receiver and the counter value remains equal to the initial value (for example, zero). In any case, if the detection module does not detect any anomaly in the current measurement window, the counter value is preferably reset to the initial value.

If the detection module detects an anomaly in the considered measurement window, it preferably issues an alarm warning related to the considered optical channel (steps 304 and 305) in the form of a signalling message that can be made available to an operator. Moreover, the detection module preferably updates (i.e., increases by one unit) the counter indicating the number of detected anomalies.

Furthermore, the detection module preferably compares the counter value with a pre-defined threshold AN, where AN is an integer number greater than or equal to 1 (step 306). If the counter value does not exceed the threshold AN, the steps 301, 302 and 303 are preferably repeated in relation to the next measurement window.

In the event that the counter value is equal to the pre-defined threshold AN (namely, in case the detection module has detected a number AN of consecutive anomalies), the detection module preferably issues an anomaly alarm relating to the considered optical channel (step 307). The anomaly alarm is preferably issued in the form of a signalling message sent to the identification module.

The value of the threshold AN can be set to 1, in which case the anomaly alarm is issued upon detection of every single anomaly found in the samples of the transmission parameter, or it can be set at an integer value greater than 1, in which case the anomaly alarm is issued upon detection of a sequence of successive anomalies found in the samples of the transmission parameter. The pre-defined value of the threshold AN can be set by the network operator.

In addition to or as an alternative to what is described above, the anomaly alarm can also be generated “manually” by the operator once the detection module has generated a number AN of consecutive alarm warnings.

The value of the threshold AN can be pre-determined by observing, for example, historical data of measurements of the transmission parameter in absence and in the presence of malfunctions. In case that the considered transmission parameter is the pre-FEC BER, the value AN can, for example, depend on a pre-defined pre-FEC BER value above which the receiver performances are considered unacceptable (for example, 0.01% or 0.1%) due to the considered malfunction. In this case, the threshold value AN can be determined on the basis of the number of anomalies detected by the first classifier in the historical measurement data before the value of the pre-FEC BER exceeds the value considered unacceptable. The value of AN may also depend on the time anticipation that is to be obtained for the anomaly alarm with respect to the moment in which the pre-FEC BER reaches the value which is considered unacceptable (i.e., with respect to the actual moment in which the malfunction occurs).

According to the present invention, upon receiving the anomaly alarm, the identification module preferably executes an identification algorithm that identifies the cause of the subsequent failure indicated by the anomaly/anomalies. Preferably, the identification module uses the same input data of the detection module. In particular, the identification algorithm preferably maps the input data of the current measurement window (namely, the window in which the last anomaly of the sequence of AN successive anomalies was detected) into a class within a set of identification classes of the malfunction cause (step 308). Alternatively, the execution of the identification algorithm of step 308 may provide mapping in a respective identification class the input data of each measurement window of the sequence of AN measurement windows for which at step 305 an alarm warning was issued, or the last AN′ measurement windows of the sequence, wherein AN′ is an integer number greater than or equal to 1 and smaller than AN. In this case, the identification of the malfunction cause can, for example, be carried out automatically by considering, at the end of step 308, the identification class most populated by the obtained results, or it can be determined by an operator analyzing the obtained results, window after window.

The set of identification classes preferably corresponds to a pre-defined set of causes which comprises, for example: misalignment of the filters of the considered optical channel, excessive attenuation of the optical channel, malfunction of lasers and/or photodiodes, bending of the optical fiber, or a combination of them.

Thanks to the identification performed by the method according to the present invention, it is possible to identify a system failure in advance of its actual occurrence. In particular, thanks to the present invention, it is possible to identify the malfunctioning network device or devices before this malfunction causes their failure, with consequent interruption of the optical channel. Therefore, in this way it is possible to guarantee a timely repair, reconfiguration or, possibly, replacement of the device. While the device is being repaired, reconfigured or replaced, it is possible to reconfigure the optical channel affected by the identified soft-failure so that no violation of the Service Level Agreement (SLA) agreed on the offered service occurs and therefore the Quality of Service (QoS) offered to the end user is respected.

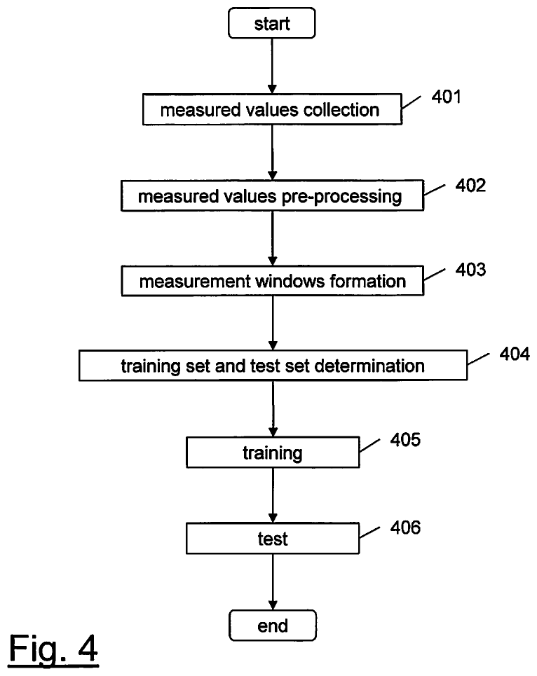

In the following description, the detection and identification modules of the present invention will be described more in detail. This description will refer to the flowchart of FIG. 4.

According to embodiments of the present invention, the detection algorithm preferably comprises a first classifier, preferably based on a Machine Learning (ML) technique. The ML technique of the first classifier can be one of the following: binary Support Vector Machine (SVM), Random Forest (RF), multiclass SVM, artificial Neural Network (NN). As already mentioned above, according to these embodiments, the first classifier is configured to automatically detect the presence or absence of an anomaly within each considered measurement window, starting from input data (corresponding to the so-called “features” in the terminology typically used to describe ML techniques) obtained from the values of the transmission parameter. In particular, the first classifier preferably maps the input data obtained from the values of the transmission parameter in a measurement window into a first class corresponding to the presence of an anomaly or a second class corresponding to the absence of the anomaly. According to other embodiments of the present invention, the detection algorithm can be based on other anomaly detection techniques in the measurement windows preceding the actual occurrence of a failure, for example techniques based on the comparison between the transmission parameter values of the considered windows and appropriate thresholds.

According to the method of the present invention, the identification algorithm comprises a second classifier, preferably based on a ML technique. The ML technique of the second classifier can be an artificial neural network. As already mentioned above, according to the present invention, the second classifier is configured to automatically carry out the identification of the failure cause by analyzing the effect that the failure causes on the values of the transmission parameter measured at the receiver inside the measurement windows corresponding to the detected anomalies. In particular, the second classifier preferably maps the input data obtained from the values of the transmission parameter in a measurement window into a class belonging to a pre-defined set of classes, each one corresponding to a different cause of failure.

According to preferred embodiments of the present invention, both the first classifier and the second classifier are preferably based on a ML technique. As known, these types of classifiers are taught by means of an automatic learning procedure, in particular semi-supervised or fully supervised.

FIG. 4 shows the flowchart of the procedure used for the learning of both the first classifier and the second classifier according to preferred embodiments of the present invention.

During an initial configuration procedure of the monitoring unit, before the detection and identification modules are put into operation on field, the receiver preferably measures the values of the considered transmission parameter related to the optical channel under exam for a sufficient time to collect data for the training of the classifiers. The measurements of the transmission parameter collected during this procedure comprise both measures indicating the absence of anomalies and measures indicating the presence of anomalies due to the possible causes of the failure on the considered optical channel. As anticipated above, each possible cause is in fact associated with a respective class of the set of identification classes of the second classifier. This initial measurement time will hereinafter be referred to also as “training data collection campaign”. During this campaign, the receiver preferably samples the value of the transmission parameter with a pre-defined period T, which may be comprised, for example, between 3 seconds and 110 seconds (step 401).

At step 402, the data acquisition module, after having acquired the samples measured by the receiver, preferably performs a pre-processing of the samples themselves, for example to reduce the noise (step 402). In accordance with what has been described above, the values collected and pre-processed by the data acquisition module are organized into a series of measurement windows of the transmission parameter (step 403), each window having a duration W which can be comprised between 5 and 300 minutes, for example 15 minutes. Within each measurement window, the number of samples of the transmission parameter is equal to C=W/T. For the learning data collection, preferably all the measurement windows contain the same number of samples C and can be disjoint (no common sample) or partially overlapped one with respect to the next window. In other words, each measurement window of the transmission parameter may comprise one or more samples of the transmission parameter which are also common to one or more successive measurement windows: for example, each window may contain a number C of samples of the transmission parameter, of which the first C′<C samples also belong to the previous window. It is assumed that N indicates the number of measurement windows of the transmission parameter that are collected during the initial configuration procedure.

At step 403, preferably, the data of the measurement windows of the transmission parameter collected during the training data collection campaign are stored in a database.

Once the learning data has been collected, at step 404, the data acquisition module preferably determines, starting from the values of each measurement window of these data, one or more input data for the considered classifier. In particular, according to some embodiments of the present invention, the same input data used for the first classifier are also used as input data for the second classifier (during both the learning procedure and during on-field operation). To determine the input data, the data acquisition module can also determine a spectrum of the values of the considered measurement window, by applying the known Fast Fourier Transform (FFT) algorithm. For example, the input data may comprise: an average value of the samples, a maximum value of the samples, a minimum value of the samples, a standard deviation of the samples, a mean square value of the samples, a peak-to-peak value of the samples (i.e., a difference between the minimum value and the maximum value), one or more values of the spectrum.

At same step 404, the data acquisition module preferably organizes the input data into corresponding multidimensional vectors (input vectors), wherein each input vector is associated with a related measurement window of the transmission parameter. In the following description, the following notation will be used to indicate a generic input vector:

IVᵢ={x₁ᵢ;x₂ᵢ; . . . ;x_{Mi}}

wherein i (i=1, . . . , N) is an integer index indicating the single measurement window, N in an integer number greater than or equal to 1 indicating the total number of considered measurement windows, M is an integer number, greater than or equal to 1, indicating the number of input data of each input vector, and x₁ᵢ, x₂ᵢ, . . . , x_{Mi} are the values of the input data corresponding to the i-th measurement window.

Each input vector (and therefore the data related to each measurement window) is then associated with a corresponding output vector of the first classifier. In particular, each input vector corresponding to the presence of an anomaly in the related measurement window is associated with a first output vector of the first classifier, in turn associated with the first class of the detection algorithm; similarly, each input vector corresponding to the absence of an anomaly in the related measurement window is associated with a second output vector of the first classifier, in turn associated with the second class of the detection algorithm. In the following description, the following notation will be used to indicate a generic output vector of the first classifier:

OV1ᵢ={yᵢ},

wherein yᵢ is the value of the only output data corresponding to the i-th measurement window. Indeed, since the first classifier performs a binary classification of the input data, each output vector can comprise only one value yᵢ. For example, it is possible to set yᵢ=1 to indicate the presence of an anomaly, and yᵢ=0 to indicate the absence of an anomaly.

Moreover, according to the above mentioned embodiments of the present invention, each input vector IVᵢ is also associated with a corresponding output vector of the second classifier. In the following description, the following notation will be used to indicate a generic output vector of the second classifier.

OV2ᵢ={y₁ᵢ;y₂ᵢ; . . . ;y_{Pi}},

wherein P is an integer number, greater than or equal to 1, indicating the number of output data of each output vector of the second classifier, and y₁ᵢ, y₂ᵢ, . . . , y_{Pi} are the values of the output data corresponding to the i-th measurement window. The number P, preferably, depends on the number of the classes of the classifier. In particular, according to embodiments of the present invention, the output vector is a vector of binary values with a dimension equal to the number of classes, wherein all the vector components are equal to zero with the exception of the component corresponding to the identified class, which can be set to 1. For example, if P=4, i.e. if the classes are four, indicated for example as C1, C2, C3, C4, an output vector identifying the cause associated with class C2 could be the following: {0; 1; 0; 0}.

Each pair comprising an input vector and the corresponding output vector for the first classifier, obtained with the data collected during the training data collection campaign, forms a so-called “example” useful for the learning of the detection algorithm. Similarly, each pair comprising an input vector and the corresponding output vector for the second classifier, obtained with the data collected during the training data collection campaign, forms a so-called “example” useful for the learning of the identification algorithm. Each example corresponds to a respective measurement window of the transmission parameter. For each classifier, from the set of related examples, a respective sub-set of training examples (also called “training set”) and a respective sub-set of test examples (also called “test set”) are extracted.

During step 405, the detection module preferably performs a semi-supervised or fully supervised learning technique to train the first classifier using the examples of the corresponding training set. Similarly, the identification module preferably performs a semi-supervised or fully supervised learning technique to train the second classifier using the examples of the corresponding training set.

Furthermore, both the detection module and the identification module preferably perform a cross-validation technique to iteratively optimize the detection algorithm and the identification algorithm, respectively (phase not shown in the flowchart of FIG. 4) during the training phase. The technique used can be, for example, the known “Leave-One-Out Cross Validation” technique. As known, the application of a cross-validation technique advantageously allows to avoid the so-called “overfitting” and to reduce the error on the test examples. For example, in case the classifier comprises an artificial neural network, it is possible to optimize the number of intermediate layers of the network and the number of nodes of each intermediate layer. If the classifier comprises an SVM (binary or multiclass), it is possible to optimize the kernel type, while if the classifier comprises a random forest it is possible to optimize the number of trees.

At the end of the actual training phase of each classifier, the detection module and the identification module preferably perform a test procedure of the respective classifier (step 406) using the examples of the corresponding test set.

Once the first classifier and the second classifier have been trained as described above, the detection module and the identification module are able to operate “on field” (i.e., they are able to operate during normal operation of the system 1 after the training data collection campaign) to, respectively, detect the anomalies in the measurement windows of the transmission parameter and identify the cause thereof, according to what has already been described above with reference to the flowchart of FIG. 3.

It should be noticed that, according to the present invention, the data collection procedure for determining the set of examples used for the training and testing of the detection and identification algorithms, which has been described above with reference to the initial configuration phase of the detection and identification modules, continues to be performed even during normal operation of the considered optical communications system. In this way, advantageously, the set of examples available for the learning of the detection and identification algorithms can be continuously adapted to the variable conditions of the optical communications system and in particular of the optical communications network. In this way, advantageously, the detection and identification modules can learn what the trend of the considered transmission parameter is in the presence of failures associated with not previously known or not previously observed causes.

According to preferred embodiments of the present invention, the transmission parameter used to implement both the detection algorithm and the identification algorithm is the pre-FEC BER measured at the receiver. According to an exemplary embodiment of the present invention, each input vector IVᵢ for both the first and second classifier may comprise the following 16 features:
x₁ᵢ=mean value of the BER within the i-th measurement window;
x₂ᵢ=mean square value of the BER within the i-th measurement window;
x₃ᵢ=peak to peak value of the BER (namely, the difference between the minimum value of the BER and the maximum value) within the i-th measurement window;
x₄ᵢ=standard deviation of the BER within the i-th measurement window;
x₅ᵢ=maximum value of the BER within the i-th measurement window;
x₆ᵢ=minimum value of the BER within the i-th measurement window;
x₇ᵢ-x₁₆ᵢ=10 greatest values of the BER spectrum obtained by applying the FFT to the samples of the i-th measurement window.

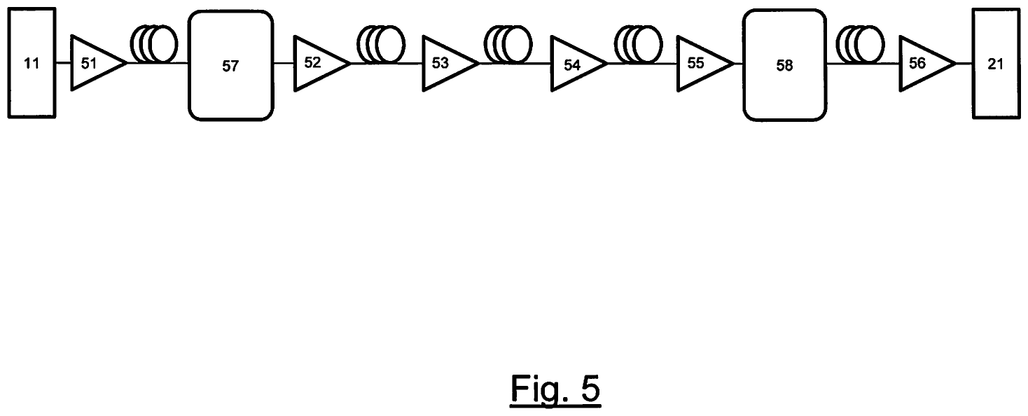

FIG. 5 schematically shows an exemplary optical communications system used to test the method according to the present invention. In particular, the system shown in FIG. 5 is a scheme of an Ericsson transmission system 380 km long comprising a transmitter, which for simplicity may correspond to the first transmitter 11 of FIG. 1, and a receiver, which for simplicity may correspond to the second receiver 21 of FIG. 1. The system uses a PM-QPSK modulation at a transmission rate of 100 Gb/s and 30.071 Gbaud. The signal is amplified through a series of 6 amplifiers 51, 52, 53, 54, 55, 56 of the EDFA type (Erbium Doped Fiber Amplifier) followed by VOA (Variable Optical Attenuator) attenuators. The system also comprises a first BV-WSS (Bandwidth Variable—Wavelength Selective Switch) switch 57 which is configured to introduce a malfunction in the system that emulates one of two typical malfunctions: a filter misalignment or an unwanted amplifier gain reduction (i.e., excessive attenuation of the optical channel). The system also comprises a second BV-WSS switch 58 which does not introduce any malfunction since it is only used to reduce the noise at the receiver. The optical fiber portion between the first amplifier 51 and the first switch 57 is 60 km long while the other portions are 80 km long.

The method according to the present invention was tested by the inventors considering a set of examples obtained during a training data collection campaign by measuring the pre-FEC BER at the receiver for a period of 24 hours, considering a sampling period of the BER equal to 3 seconds.

Four different failure detection algorithms were tested, based on four different ML techniques, and a failure identification algorithm. These algorithms (referred to as algorithm A, algorithm B, algorithm C, algorithm D and algorithm E) will be schematically described below.

Algorithm A
ML technique: binary SVM
Kernel: Radial Basis Function (gamma=0.1)
Number of training examples: between 500 and 3400 examples with no anomaly
Number of test examples: between 200 and 700 examples with no anomaly, and 2000 examples with anomaly
Validation technique: Leave-One-Out Cross Validation
Input data (i-th example): 16 data x₁ᵢ-x₁₆ᵢ as indicated above
Output data (i-th example): yᵢ=1 in presence of anomaly, yᵢ=0 in absence of anomaly

### Algorithm B

ML technique: multiclass SVM
Kernel: third degree polynomial
Number of training examples: 3000 examples with no anomaly, 2000 examples with anomaly
Number of test examples: 1000
Validation technique: Leave-One-Out Cross Validation
Input data (i-th example): 16 data x₁ᵢ-x₁₆ᵢ as indicated above
Output data (i-th example): yᵢ=1 in presence of anomaly, yᵢ=0 in absence of anomaly

### Algorithm C

ML technique: RF
Split criterion: Gini Impurity
Number of training examples: 3000 examples with no anomaly, 2000 examples with anomaly
Number of test examples: 1000
Validation technique: Leave-One-Out Cross Validation
Input data (i-th example): 16 data x₁ᵢ-x₁₆ᵢ as indicated above
Output data (i-th example): yᵢ=1 in presence of anomaly, yᵢ=0 in absence of anomaly

### Algorithm D

ML technique: artificial neural network
Number of hidden layers: 1
Number of nodes of the hidden layer: 10
Activation function: Relu (Rectified linear unit)
Optimizer: L-BFGS (Limited-memory Broyden-Fletcher-Goldfarb-Shannon) algorithm
Number of training examples: 3000 examples with no anomaly, 2000 examples with anomaly
Number of test examples: 1000
Validation technique: Leave-One-Out Cross Validation
Input data (i-th example): 16 data x₁ᵢ-x₁₆ᵢ as indicated above
Output data (i-th example): yᵢ=1 in presence of anomaly, yᵢ=0 in absence of anomaly

While algorithm A is a semi-supervised classification algorithm, algorithms B, C and D are fully supervised algorithms. Therefore, for the algorithm A fewer training examples are sufficient with respect to the other algorithms and in particular it is not necessary to provide examples representative of the “anomalous” situation, i.e. examples related to the presence of anomaly, but only examples representative of the absence of anomaly in the measurement windows.

As far as failure identification is concerned, the following algorithm was tested:

### Algorithm E

ML technique: artificial neural network
Number of hidden layers: 2
Number of nodes of each hidden layer: 5
Activation function: Relu (Rectified linear unit)
Optimizer: Stochastic gradient descent algorithm
Number of training examples: from 1800 to 2000 (of which about 50% are examples of filter misalignment and about 50% are examples of excessive attenuation)
Number of test examples: 600
Validation technique: Leave-One-Out Cross Validation
Input data (i-th example): 16 data x₁ᵢ-x₁₆ᵢ as indicated above
Output data (i-th example): {1; 0} in presence of filter misalignment, {0; 1} in presence of excessive attenuation

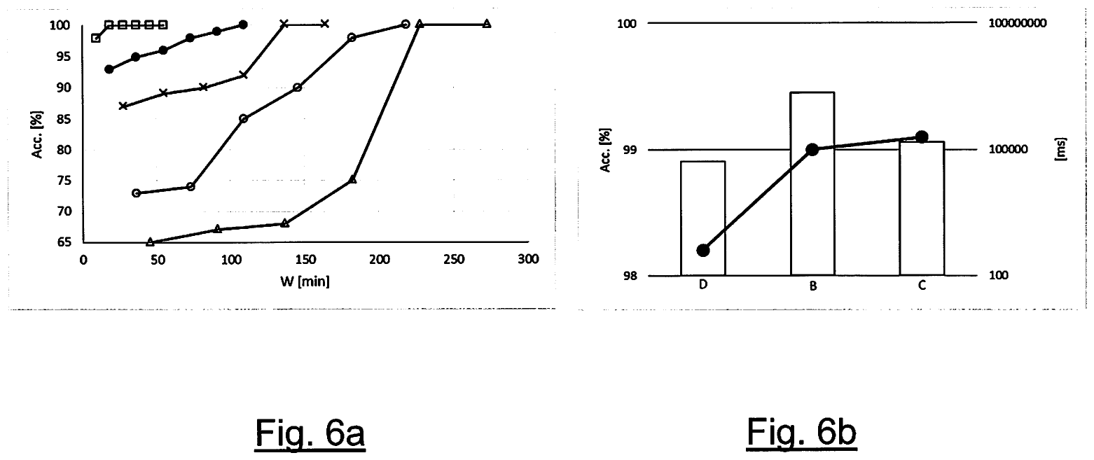

FIGS. 6a and 6b illustrate the results of the test performed on the system of FIG. 5 for the detection algorithms. In particular, the graph in FIG. 6a shows, on the axis of the ordinates, the accuracy of the classification results of algorithm A (the accuracy is indicated as “Acc.” and expressed as a percentage) as a function of the duration W of the measurement window (shown on the axis of the abscissae, expressed in minutes), for different values of the sampling period T of the pre-FEC BER within the measurement window. The accuracy was determined as the ratio between the number of correctly classified test examples and the total number of used test examples. The following values were considered for the sampling period T: 22 s, 44 s, 66 s, 88 s, 110 s. In particular, square markers were used for the graph related to T=22 s, full circular markers for the graph related to T=44 s, cross-shaped markers for the graph related to T=66 s, empty circular markers for the graph related to T=88 s, and triangular markers for the graph related to T=110 s.

From the graph it is possible to observe that, for reduced values of the sampling period, a window of reduced duration is sufficient to collect a number of BER samples useful to optimize the accuracy: the accuracy indeed reaches 100% for a window of duration equal to about 18 minutes. For higher values of the BER sampling period, a longer duration of the measurement window is required to ensure that a larger number of BER samples are considered, from which to extract significant input data. For example, for a sampling period T equal to 44 s, the measurement window must have a duration of about 73 minutes to obtain 98% accuracy.

The graph in FIG. 6b shows, on the left axis of the ordinates, the accuracy of the algorithms B, C and D (the accuracy is indicated as “Acc.” and expressed as a percentage) together with a measure of their computational complexity expressed in terms of the duration of the learning phase (shown on the right axis of the ordinates and expressed in ms). For each algorithm, the used values of the sampling period T and of the duration W of the measurement window are those corresponding to the maximum accuracy provided by each algorithm when these parameters vary, i.e. T=22 s and W=36 minutes. As can be seen from the graph, the algorithm D is the one showing the lowest computational complexity, but which provides, on the other hand, the most reduced accuracy (98.2%). The algorithm B provides greater accuracy than the algorithm D (99%) but requires longer times for the learning. The algorithm C provides a compromise between accuracy and complexity: it provides the highest accuracy (99.1%) in the face of a much lower complexity than the algorithm B.

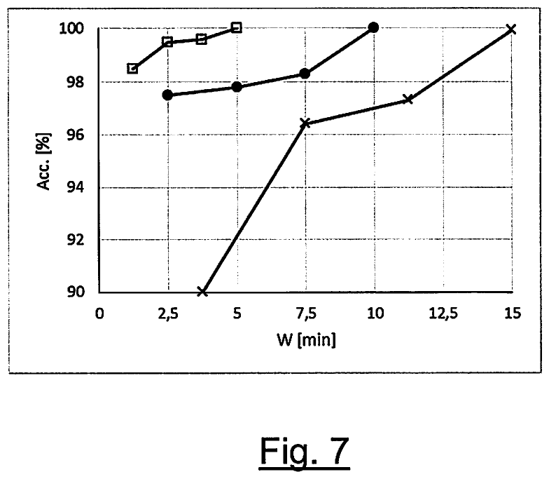

FIG. 7 shows, on the axis of the ordinates, the accuracy of the results of the algorithm E (the accuracy is indicated as “Acc.” and expressed as a percentage) as a function of the duration W of the measurement window (on the axis of the abscissae, expressed in minutes), for different values of the sampling period T of the BER in the measurement window (3 s, 6 s, 9 s). In particular, square indicators were used for the graph related to T=3 s, full circular markers for the graph related to T=6 s, and cross-shaped markers for the graph related to T=9 s. As can be seen, accuracy improves with the increasing duration of the measurement window. In addition, for a given duration of the measurement window, accuracy decreases as the sampling period value increases, since the amount of BER samples from which to extract the input data is reduced. In general, a measurement window of about 15 minutes of duration is sufficient to provide 100% accuracy for any value of the BER sampling period.

Advantageously, the results of the tests carried out by the inventors show that the detection and identification algorithms of the method according to the present invention allow to detect the anomalies present in the measurement windows and to identify their cause. This advantageously allows a rapid detection of a soft-failure before it occurs so that the network operator can quickly implement specific failure repair procedures in order to guarantee the QoS agreed with its customers. This also allows to limit the costs, otherwise necessary, to implement the traditional failure individuation measures. The described method guarantees an automatic individuation of the cause of the soft-failure that allows to reduce the average time required to repair the fault (or Mean Time to Repair, MTTR). Furthermore, the fact that most malfunctions can be foreseen and avoided increases the availability of the offered service. Moreover, the described method avoids the implementation of protection systems and therefore over-dimensioning the devices to be deployed in the network.

From the end users' point of view, the described method allows to improve the quality of the service offered to them, as it allows to avoid that the service is interrupted due to a soft-failure.

It should also be noticed that the method according to the present invention can be adapted to identify not only causes of failures that are pre-defined during an initial configuration phase, as described above, but also to “learn” to identify causes of failures that are not yet known or not previously observed in the considered system. It is therefore evident that it can be applied to any optical communications system and network, which are not necessarily known a priori in structure and composition. In particular it can be adapted to different types of optical communications systems having, for example, different geographical scales or different number and type of devices. In fact, the use of the ML techniques described above allows advantageously to ad-hoc train the identification algorithm depending on the features of the system and the possible causes of failures but also to identify the “new causes” that may arise during the functioning of the system. This can be achieved by adding new classes to the classifier output data and adding new examples to the set of examples used for learning, where the new examples include measurement windows whose samples are indicative of the new types of failures.

Finally, the use of ML techniques for the failure detection and identification algorithms according to the present invention allows to create a monitoring method based on direct relationships between the transmission parameters, in particular their trend in the measurement windows, and the causes of the failures that have caused precisely that particular trend, exploiting data representative of the “history” of the monitored system. The fact that the method provides for continuously measuring the transmission parameters at the receivers and collecting data for the learning examples set allows, in fact, advantageously, to obtain a highly adaptive and flexible method with respect to the dynamic conditions of the monitored system.

1. A method for monitoring an optical communications system comprising at least one optical channel connecting a transmitter and a receiver, said method comprising:
a) measuring, at said receiver, a transmission parameter of said optical channel for a pre-defined measuring time interval;
b) on the basis of the measurements of said transmission parameter in said time interval, checking the presence of at least one anomaly in said measurements, said at least one anomaly being indicative of a subsequent failure of said system; and
c) in the presence of said at least one anomaly, applying an identification algorithm to said measurements, said algorithm comprising a classifier, wherein the classifier is configured to, on the basis of said measurements, identify a cause of said failure, said classifier being based on a machine learning technique.

2. The method according to claim 1, wherein said step a) comprises:
a1) sampling the values of said transmission parameter in said interval with a pre-defined period and collecting said samples in a measurement window of said transmission parameter having a pre-defined duration; and
a2) determining, starting from said samples, one or more input data for said classifier,
wherein said input data comprises one or more statistical values related to the samples of the transmission parameter in said measurement window.

3. The method according to claim 2, wherein said statistical values comprise one or more of the following: a mean value, a maximum value, a minimum value, a standard deviation, a mean square value, a peak-to-peak value, one or more spectrum components of the samples.

4. The method according to claim 2, wherein said method comprises collecting the samples of said transmission parameter in at least two consecutive measurement windows, wherein said at least two measurement windows are disjoint or at least partially overlapped, checking the presence of an anomaly in each measurement window of said at least two measurement windows and, in the presence of an anomaly in each measurement window, applying said identification algorithm.

5. The method according to claim 1, wherein said transmission parameter is the pre-FEC BER associated with said optical channel.

6. The method according to claim 1, wherein said machine learning technique comprises an artificial neural network.

7. The method according to claim 1, wherein said step b) comprises applying a detection algorithm to said measurements, said detection algorithm comprising a further classifier based on a further machine learning technique.

8. The method according to claim 7, wherein said further machine learning technique comprises one of the following: binary support vector machine, random forest, multiclass SVM, artificial neural network.

9. The method according to claim 1, wherein said method further comprises an initial configuration step, and said initial configuration step comprises applying an automatic learning algorithm to train said classifier based on a set of measurements of said transmission parameter, said set of measurements being indicative of at least two possible causes of said failure.

10. A monitoring unit for an optical communication system, said system comprising at least one optical channel connecting a transmitter and a receiver, said unit comprising:
a data acquisition module configured to collect from said receiver measurements of a transmission parameter of said optical channel for a pre-defined measuring time interval;
a detection module configured to, on the basis of the measurements of said transmission parameter in said time interval, check the presence of at least one anomaly in said measurements, said at least one anomaly being indicative of a subsequent failure of said system; and
an identification module configured to, in the presence of said at least one anomaly, apply an identification algorithm to said measurements, said algorithm comprising a classifier, wherein the classifier is configured to, on the basis of said measurements, identify a cause of said failure, said classifier being based on a machine learning technique.
